(19) United States
(12) Patent Application Publication
(10) Pub. No.: US 2023/0098858 A1
(43) Pub. Date: Mar. 30, 2023

(54) INFORMATION PROCESSING DEVICE AND INFORMATION PROCESSING METHOD

(71) Applicant: Mitsubishi Electric Corporation, Tokyo (JP)

(72) Inventor: Kensho MOTOE, Tokyo (JP)

(73) Assignee: Mitsubishi Electric Corporation, Tokyo (JP)

(21) Appl. No.: 18/075,442

(22) Filed: Dec. 6, 2022

Related U.S. Application Data
(63) Continuation of application No. PCT/JP2020/029921, filed on Aug. 5, 2020.

(51) Int. Cl. G06F 11/34

(52) U.S. Cl. CPC G06F 11/348; G06F 11/3438

(57) ABSTRACT

An information processing device includes: an operation determining unit that determines whether or not a function input operation performed by the user is an operation intended by the user, by determining whether or not the function input operation performed by the user is a repetition of a predetermined operation pattern, on the basis of a plurality of pieces of function operation information corresponding to the function input operation among a plurality of pieces of operation information obtained by an operation obtaining unit, the function input operation being an input operation for allowing a function of a device to be performed; and a notification output unit that outputs, when the operation determining unit determines that the function input operation performed by the user is not an operation intended by the user, notification information indicating that the user has performed the function input operation by repeating the predetermined operation pattern.

### CROSS-REFERENCE TO RELATED APPLICATION

The present application is a bypass continuation of PCT filing PCT/JP2020/029921, filed Aug. 5, 2020, the entire contents of which are incorporated herein by reference.

### TECHNICAL FIELD

The present disclosure relates to an information processing device and an information processing method.

### BACKGROUND ART

There is an information processing device that monitors whether or not an interruption process has occurred a plurality of times within a predetermined period of time, on the basis of an operation history managed by a log managing unit, and displays guidance on a function to be selected on the basis of the operation history managed by the log managing unit, when occurrence of a plurality of interruption operations within a predetermined period of time has been monitored on the basis of occurrence of the interruption operations, thereby providing guidance to a user who repeats an interruption operation because the user does not know about an operation procedure (see, for example, Patent Literature 1).

The conventional information processing device is to monitor occurrence of an interruption operation that interrupts a function of a device.

### CITATION LIST

### Patent Literature

Patent Literature 1: JP 2017-73596 A

### SUMMARY OF INVENTION

### Technical Problem

When, for example, despite the fact that a user has already performed an input operation for allowing a function of a device to be performed, the user has forgotten about him/her having performed the input operation, the user may newly perform an input operation for allowing the function of the device to be performed.

The conventional information processing device is to monitor occurrence of an interruption operation that interrupts a function of a device, and thus, when the user has repeatedly performed an input operation for allowing a function of the device to be performed, the conventional information processing device has a problem that the input operation having been repeatedly performed by the user cannot be detected.

The present disclosure is to solve the above-described problem, and an object of the present disclosure is to provide an information processing device in which when a user has repeatedly performed an input operation for allowing a function of a device to be performed, the user can be notified of the fact that the user has repeatedly performed the input operation.

### Solution to Problem

An information processing device according to the present disclosure includes: operation obtaining circuitry to obtain operation information corresponding to an input operation performed by a user; operation determining circuitry to determine whether or not a function input operation performed by the user is an operation intended by the user, by determining whether or not the function input operation performed by the user is a repetition of a predetermined operation pattern, on a basis of a plurality of pieces of function operation information corresponding to the function input operation among a plurality of pieces of operation information obtained by the operation obtaining circuitry, the function input operation being an input operation for allowing a function of a device to be performed; and notification output circuitry to output, when the operation determining circuitry determines that the function input operation performed by the user is not an operation intended by the user, notification information indicating that the user has performed the function input operation by repeating the predetermined operation pattern.

### Advantageous Effects of Invention

According to the present disclosure, when the user has repeatedly performed an input operation for allowing a function of the device to be performed, the user can be notified of the fact that the user has repeatedly performed the input operation.

### BRIEF DESCRIPTION OF DRAWINGS

FIG. 1 is a block diagram showing an example of configurations of main parts of an information processing device according to a first embodiment and a device in which the information processing device is used.

FIGS. 2A and 2B are diagrams showing examples of a hardware configuration of the main part of the information processing device according to the first embodiment.

FIG. 3 is a flowchart that describes an example of processes performed by the information processing device according to the first embodiment.

### DESCRIPTION OF EMBODIMENTS

An embodiment of the present disclosure will be described in detail below with reference to the drawings.

### First Embodiment

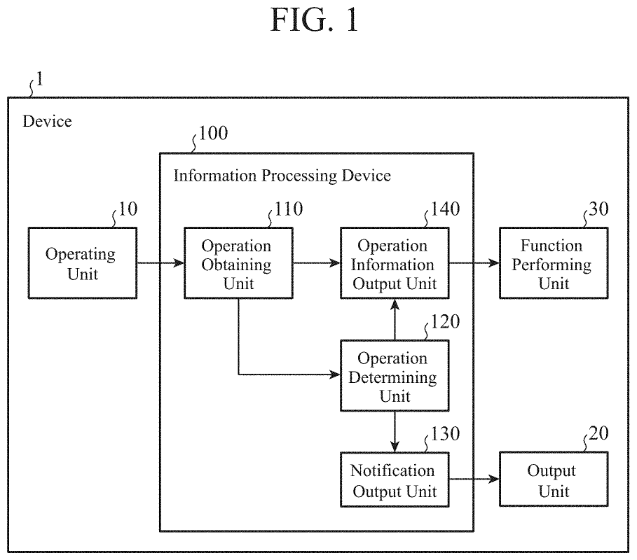

With reference to FIGS. 1 to 3, an information processing device 100 according to a first embodiment and a device 1 in which the information processing device 100 is used will be described.

FIG. 1 is a block diagram showing an example of configurations of main parts of the information processing device 100 according to the first embodiment and the device 1 in which the information processing device 100 is used.

The device 1 includes an operating unit 10, an output unit 20, a function performing unit 30, and the information processing device 100.

The device 1 is a home appliance such as a rice cooker, a microwave oven, an air conditioner, or a television set.

The device 1 is not limited to a home appliance. For example, the device 1 may be a portable terminal such as a smartphone or a tablet terminal, or may be a smart speaker that searches for specified information or controls a home appliance that works together with the smart speaker, on the basis of specified information.

The operating unit 10 is to allow a user to perform input operations for controlling the device 1, and includes buttons, dials, or the like. The operating unit 10 receives an input operation from the user and outputs operation information corresponding to the input operation to the information processing device 100.

The operating unit 10 is not limited to including buttons or dials, and may include, for example, a touch operation means including a touch panel, etc., or may include a voice input operation means including a voice input means such as a microphone and a voice analysis obtaining means for obtaining voice analysis information corresponding to voice obtained by the microphone.

In addition, the operating unit 10 is not limited to being included in a main body of the device 1 as long as the operating unit 10 is to allow the user to perform input operations for controlling the device 1, and may be constituted by a remote control device that is provided separately from the main body of the device 1, such as a remote controller.

The information processing device 100 obtains operation information outputted from the operating unit 10, performs a predetermined process on the basis of the obtained operation information, and outputs notification information to the output unit 20. The information processing device 100 is not limited to being included in the main body of the device 1 as long as the information processing device 100 obtains operation information outputted from the operating unit 10 and outputs notification information to the output unit 20. For example, when the operating unit 10 is constituted by a remote control device that is provided separately from the main body of the device 1, the information processing device 100 may be included in the remote control device.

When the operating unit 10 is constituted by a remote control device that is provided separately from the main body of the device 1 and the information processing device 100 is included in the main body of the device 1, operation information corresponding to an input operation performed on the operating unit 10 by the user is outputted to the information processing device 100 through a wireless communication means such as infrared communication, Bluetooth (registered trademark), a wireless local area network (LAN), or long term evolution (LTE).

Details of the information processing device 100 will be described later.

The output unit 20 is constituted by a display device such as a display or an audio output device such as a speaker, and obtains notification information outputted from the information processing device 100 and performs display output or audio output based on the obtained notification information.

The output unit 20 is not limited to being included in the main body of the device 1 as long as the output unit 20 obtains notification information outputted from the information processing device 100 and performs display output or audio output based on the obtained notification information. For example, when the operating unit 10 is constituted by a remote control device that is provided separately from the main body of the device 1, the output unit 20 may be included in the remote control device.

When the output unit 20 is included in the remote control device and the information processing device 100 is included in the main body of the device 1, notification information outputted from the information processing device 100 is outputted to the output unit 20 through a wireless communication means such as infrared communication, Bluetooth (registered trademark), a wireless LAN, or LTE.

The function performing unit 30 performs functions of the device 1. Specifically, on the basis of operation information outputted from the information processing device 100 as a result of the information processing device 100 performing a predetermined process on the basis of operation information obtained by the information processing device 100 from the operating unit 10, the function performing unit 30 performs one of the functions of the device 1, the one function corresponding to the operation information.

The functions of the device 1 referred to here include, for example, when the device 1 is a rice cooker, a rice cooking function that cooks rice, etc., a rice cooking reservation function that specifies a time at which cooking of rice starts or is completed, or the like. In addition, for example, when the device 1 is a microwave oven, the functions of the device 1 include a heating function that heats foods, etc., arranged in the microwave oven, or the like. In addition, for example, when the device 1 is an air conditioner, the functions of the device 1 include a cooling function, a heating function, or a dehumidification function that adjusts temperature or humidity in a room, a temperature setting function or a humidity setting function that sets a target value of temperature or humidity in a room, or the like. In addition, for example, when the device 1 is a television set, the functions of the device 1 include a video output function that performs display output and audio output of an image and audio based on an inputted video signal, a video signal switching function that switches between video signals to be inputted, a volume setting function that sets volume at which audio output is performed, or the like.

The information processing device 100 will be described.

The information processing device 100 includes an operation obtaining unit 110, an operation determining unit 120, a notification output unit 130, and an operation information output unit 140.

The operation obtaining unit 110 obtains operation information corresponding to an input operation performed by the user. Specifically, for example, the operation obtaining unit 110 obtains operation information outputted from the operating unit 10, thereby obtaining operation information corresponding to an input operation performed by the user.

On the basis of a plurality of pieces of operation information (hereinafter, referred to as “function operation information”) corresponding to an input operation (hereinafter, referred to as “function input operation”) for allowing a function of the device 1 to be performed, among a plurality of pieces of operation information obtained by the operation obtaining unit 110, the operation determining unit 120 determines whether or not the function input operation performed by the user is a repetition of a predetermined operation pattern, thereby determining whether or not the function input operation performed by the user is an operation intended by the user.

Specifically, for example, the operation determining unit 120 determines whether or not a function input operation performed by the user is a repetition of a predetermined operation pattern, by determining, on the basis of a plurality of pieces of function operation information obtained by the operation obtaining unit 110, whether or not the operation obtaining unit 110 has repeatedly obtained a single type of predetermined function operation information within a predetermined period.

When the device 1 is a rice cooker, the single type of predetermined function operation information is, for example, operation information corresponding to an input operation for allowing the device 1 to perform the rice cooking function (hereinafter, referred to as “rice cooking start operation”). In this case, the operation determining unit 120 determines whether or not the operation obtaining unit 110 has repeatedly obtained the operation information within a predetermined period. In this case, the predetermined period is, for example, a period from when the operation obtaining unit 110 obtains operation information for the first time that corresponds to the rice cooking start operation to when the device 1 completes performance of the rice cooking function. Namely, in this case, the predetermined period is, for example, a period during which the device 1 is cooking rice (hereinafter, referred to as “rice cooking period”).

When, during the rice cooking period, despite the fact that the device 1 is performing the rice cooking function, the operation obtaining unit 110 has obtained operation information for the second time that corresponds to the rice cooking start operation, the operation determining unit 120 determines that the function input operation performed by the user is not an operation intended by the user.

Note that when the operation obtaining unit 110 has obtained operation information for the first time that corresponds to the rice cooking start operation, since the operation obtaining unit 110 has not repeatedly obtained the operation information during the rice cooking period, the operation determining unit 120 determines that the function input operation performed by the user is an operation intended by the user.

When the operation determining unit 120 has determined that the function input operation performed by the user is an operation intended by the user, the operation information output unit 140 outputs function operation information corresponding to the function input operation obtained by the operation obtaining unit 110 to the function performing unit 30 included in the device 1.

The function performing unit 30 obtains the function operation information outputted from the operation information output unit 140, and performs a function corresponding to the function operation information. Namely, when the operation determining unit 120 has determined that the function input operation performed by the user is an operation intended by the user, the operation information output unit 140 outputs function operation information corresponding to the function input operation obtained by the operation obtaining unit 110 to the function performing unit 30 included in the device 1, to allow the function performing unit 30 to perform a function corresponding to the function operation information.

When the operation determining unit 120 has determined that the function input operation performed by the user is not an operation intended by the user, the notification output unit 130 outputs notification information indicating that the user has performed the function input operation by repeating a predetermined operation pattern, to the output unit 20 included in the device 1.

The output unit 20 obtains the notification information outputted from the notification output unit 130, and performs display output or audio output based on the obtained notification information. Namely, when it is determined that the function input operation performed by the user is not an operation intended by the user, the notification output unit 130 outputs notification information indicating that the user has performed the function input operation by repeating a predetermined operation pattern, to the output unit 20 included in the device 1, to allow the output unit 20 to perform display output or audio output based on the notification information.

Specifically, for example, when the device 1 is a rice cooker and the operation obtaining unit 110 has obtained, during a rice cooking period, operation information corresponding to a rice cooking start operation, the notification output unit 130 outputs to the output unit 20 notification information allowing the output unit 20 to perform display output or audio output of the message “A rice cooking start operation has been performed during rice cooking.”, etc.

By the configuration described above, when the user has repeatedly performed an input operation for allowing a function of the device 1 to be performed, the information processing device 100 can notify the user of the fact that the user has repeatedly performed the input operation.

When the notification output unit 130 outputs notification information, the notification output unit 130 may output the notification information including confirmation information that confirms whether or not it is acceptable to perform a function corresponding to function operation information obtained by the operation obtaining unit 110.

The output unit 20 obtains the notification information including the confirmation information and outputted from the notification output unit 130, and performs display output or audio output based on the obtained notification information.

Specifically, for example, when the device 1 is a rice cooker and the operation obtaining unit 110 has obtained, during a rice cooking period, operation information corresponding to a rice cooking start operation, the notification output unit 130 outputs, to the output unit 20, notification information allowing the output unit 20 to perform display output or audio output of the message “A rice cooking start operation has been performed during rice cooking. Do you want to stop the current rice cooking and start rice cooking over again.”, etc.

The user performs, on the operating unit 10, an input operation that indicates, for example, “Yes” or “No” in response to the confirmation information included in the notification information.

The operation obtaining unit 110 obtains operation information corresponding to the input operation from the user in response to the confirmation information included in the notification information.

When the operation obtaining unit 110 has obtained operation information corresponding to an input operation indicating “Yes”, for example, the operation information output unit 140 outputs, to the function performing unit 30, information for stopping the function being performed, and further outputs, to the function performing unit 30, function operation information that is used when the operation determining unit 120 determines whether or not the function input operation performed by the user is a repetition of a predetermined operation pattern.

In addition, when the operation obtaining unit 110 has obtained operation information corresponding to an input operation indicating “No”, for example, the operation information output unit 140 deletes function operation information that is used when the operation determining unit 120 determines whether or not the function input operation performed by the user is a repetition of a predetermined operation pattern.

By the configuration described above, when the user has repeatedly performed an input operation for allowing a function of the device 1 to be performed, the information processing device 100 can notify the user of the fact that the user has repeatedly performed the input operation, and when the input operation is an operation intended by the user, the information processing device 100 can allow the device 1 to perform a function corresponding to the input operation.

In addition, when the notification output unit 130 outputs notification information, the notification output unit 130 may output the notification information including, as operation history information, a plurality of pieces of function operation information obtained by the operation obtaining unit 110.

When the output unit 20 is a display output device, for example, the output unit 20 obtains the notification information including the operation history information, and performs display output of both notification indicated by the notification information and indicating that the user has performed the function input operation by repeating a predetermined operation pattern, and the operation history information included in the notification information.

By the configuration described above, when the user has repeatedly performed an input operation for allowing a function of the device 1 to be performed, the information processing device 100 can provide the user with information indicating a history of input operations performed by the user, while notifying the user of the fact that the user has repeatedly performed the input operation.

When the function input operation performed by the user is a repetition of a predetermined operation pattern, the operation determining unit 120 may count the number of repetitions of the operation pattern.

In a case in which when the function input operation performed by the user is a repetition of a predetermined operation pattern, the operation determining unit 120 counts the number of repetitions of the operation pattern, it is preferred that, for example, when the notification output unit 130 outputs notification information, the notification output unit 130 output the notification information in a mode corresponding to the number of repetitions counted by the operation determining unit 120.

Specifically, when the output unit 20 is a display output device, for example, when the number of repetitions is large on the basis of the number of repetitions counted by the operation determining unit 120, the notification output unit 130 outputs notification information in a mode in which the font of text displayed on the output unit 20 is large compared with a case in which the number of repetitions is small.

When the output unit 20 is a display output device, a mode of notification information that is outputted by the notification output unit 130 on the basis of the number of repetitions counted by the operation determining unit 120 is not limited to changing the font size of text displayed on the output unit 20. For example, when the output unit 20 is a display output device, as long as the notification output unit 130 outputs notification information in a mode in which text displayed on the output unit 20 attracts more user's attention when the number of repetitions is large, compared with a case in which the number of repetitions is small, for example, notification information in which the color of text is changed may be outputted or notification information in which the background color of text is changed may be outputted.

In addition, when the output unit 20 is an audio output device, for example, the notification output unit 130 outputs notification information in a mode in which volume at which the output unit 20 performs audio output is high when the number of repetitions is large on the basis of the number of repetitions counted by the operation determining unit 120, compared with a case in which the number of repetitions is small.

By the configuration described above, when the user has repeatedly performed an input operation for allowing a function of the device 1 to be performed, the information processing device 100 can notify the user of the fact that the user has repeatedly performed the input operation. Particularly, by the configuration described above, when the number of times at which the user has repeatedly performed an input operation for allowing a function of the device 1 to be performed is large, the information processing device 100 can more surely make the user aware of the notification.

In the description having been made so far, the operation determining unit 120 determines whether or not a function input operation performed by the user is a repetition of a predetermined operation pattern, by determining, on the basis of a plurality of pieces of function operation information obtained by the operation obtaining unit 110, whether or not the operation obtaining unit 110 has repeatedly obtained a single type of predetermined function operation information within a predetermined period. However, a method of determining, by the operation determining unit 120, whether or not a function input operation performed by the user is a repetition of a predetermined operation pattern is not limited to a determination as to whether or not the operation obtaining unit 110 has repeatedly obtained a single type of predetermined function operation information within a predetermined period.

For example, the operation determining unit 120 may determine whether or not a function input operation performed by the user is a repetition of a predetermined operation pattern, by determining, on the basis of a plurality of pieces of function operation information obtained by the operation obtaining unit 110, whether or not the operation obtaining unit 110 has repeatedly obtained, within a predetermined period, a set of pieces of function operation information including a plurality of different types of predetermined function operation information.

For example, when the operating unit 10 includes a plurality of remote control devices, a plurality of users may perform function input operations for allowing a plurality of functions of the device 1 to be performed, using the plurality of remote control devices.

In addition, for example, a child user, a user with a mental disorder, a neurological disorder, etc., or the like, may repeatedly perform function input operations for allowing a plurality of functions of the device 1 to be performed, despite the fact that such a user has no intention of allowing a specific function of the device 1 to be performed.

More specifically, when the device 1 is an air conditioner, for example, the above-described one or more users may possibly repeatedly perform function input operations for allowing the cooling function, heating function, and dehumidification function of the device 1 to be performed.

Even in such a case, the information processing device 100 can determine whether or not a function input operation performed by the user is a repetition of a predetermined operation pattern, by the operation determining unit 120 determining whether or not the operation obtaining unit 110 has repeatedly obtained, within a predetermined period, a set of pieces of function operation information including a plurality of different types of predetermined function operation information, on the basis of a plurality of pieces of function operation information obtained by the operation obtaining unit 110.

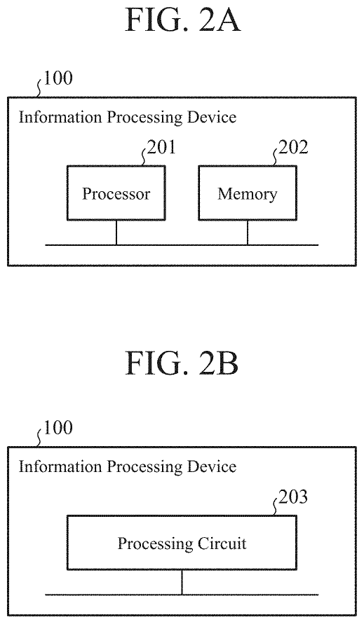

With reference to FIGS. 2A and 2B, a hardware configuration of a main part of the information processing device 100 according to the first embodiment will be described.

FIGS. 2A and 2B are diagrams showing examples of a hardware configuration of the main part of the information processing device 100 according to the first embodiment.

As shown in FIG. 2A, the information processing device 100 is constituted by a computer, and the computer has a processor 201 and a memory 202.

In the memory 202 there is stored a program for causing the computer to function as the operation obtaining unit 110, the operation determining unit 120, the notification output unit 130, and the operation information output unit 140. By the processor 201 reading and executing the program stored in the memory 202, the operation obtaining unit 110, the operation determining unit 120, the notification output unit 130, and the operation information output unit 140 are implemented.

In addition, as shown in FIG. 2B, the information processing device 100 may be constituted by a processing circuit 203. In this case, functions of the operation obtaining unit 110, the operation determining unit 120, the notification output unit 130, and the operation information output unit 140 may be implemented by the processing circuit 203.

In addition, the information processing device 100 may be constituted by the processor 201, the memory 202, and the processing circuit 203 (not shown). In this case, some of the functions of the operation obtaining unit 110, the operation determining unit 120, the notification output unit 130, and the operation information output unit 140 may be implemented by the processor 201 and the memory 202, and the other functions may be implemented by the processing circuit 203.

As for the processor 201, for example, a central processing unit (CPU), a graphics processing unit (GPU), a microprocessor, a microcontroller, or a digital signal processor (DSP) is used.

As for the memory 202, for example, a semiconductor memory or a magnetic disk is used. More specifically, as for the memory 202, for example, a random access memory (RAM), a read only memory (ROM), a flash memory, an erasable programmable read only memory (EPROM), an electrically erasable programmable read-only memory (EEPROM), a solid state drive (SSD), a hard disk drive (HDD) is used.

As for the processing circuit 203, for example, an application specific integrated circuit (ASIC), a programmable logic device (PLD), a field-programmable gate array (FPGA), a system-on-a-chip (SoC), or a system large-scale integration (LSI) is used.

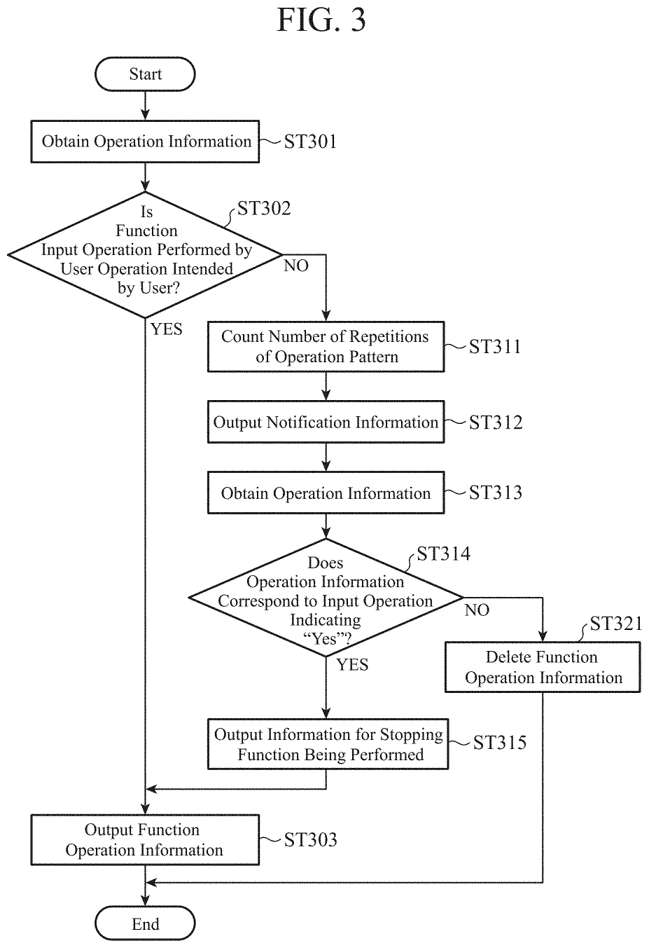

With reference to FIG. 3, the operation of the information processing device 100 according to the first embodiment will be described.

FIG. 3 is a flowchart that describes an example of processes performed by the information processing device 100 according to the first embodiment.

The information processing device 100 repeatedly performs the processes of the flowchart.

First, at step ST301, the operation obtaining unit 110 obtains operation information.

Then, at step ST302, the operation determining unit 120 determines whether or not a function input operation performed by the user is an operation intended by the user.

If the operation determining unit 120 determines, at step ST302, that a function input operation performed by the user is an operation intended by the user, then at step ST303, the operation information output unit 140 outputs function operation information to the function performing unit 30.

After step ST303, the information processing device 100 ends the processes of the flowchart, and returns to step ST301 and performs the processes of the flowchart.

If the operation determining unit 120 determines, at step ST302, that a function input operation performed by the user is not an operation intended by the user, then at step ST311, the operation determining unit 120 counts the number of repetitions of an operation pattern.

After step ST311, at step ST312, the notification output unit 130 outputs notification information.

After step ST312, at step ST313, the operation obtaining unit 110 obtains operation information corresponding to an input operation from the user in response to confirmation information included in the notification information.

After step ST313, at step ST314, the operation obtaining unit 110 determines whether or not the operation information obtained by the operation obtaining unit 110 is operation information corresponding to an input operation indicating “YES”.

If the operation obtaining unit 110 determines, at step ST314, that the operation information is operation information corresponding to an input operation indicating “YES”, then at step ST315, the operation information output unit 140 outputs information for stopping a function being performed.

After step ST315, the operation information output unit 140 performs a process at step ST303.

If the operation obtaining unit 110 determines, at step ST314, that the operation information is not operation information corresponding to an input operation indicating “YES”, i.e., if the operation obtaining unit 110 determines that the operation information is operation information corresponding to an input operation indicating “NO”, then at step ST321, the operation information output unit 140 deletes function operation information.

After step ST321, the information processing device 100 ends the processes of the flowchart, and returns to step ST301 and performs the processes of the flowchart.

As described above, the information processing device 100 includes the operation obtaining unit 110 that obtains operation information corresponding to an input operation performed by the user; the operation determining unit 120 that determines whether or not a function input operation performed by the user is an operation intended by the user, by determining whether or not the function input operation performed by the user is a repetition of a predetermined operation pattern, on the basis of a plurality of pieces of function operation information corresponding to the function input operation among a plurality of pieces of operation information obtained by the operation obtaining unit 110, the function input operation being an input operation for allowing a function of the device 1 to be performed; and the notification output unit 130 that outputs, when the operation determining unit 120 determines that the function input operation performed by the user is not an operation intended by the user, notification information indicating that the user has performed the function input operation by repeating the predetermined operation pattern.

By this configuration, when the user has repeatedly performed an input operation for allowing a function of the device 1 to be performed, the information processing device 100 can notify the user of the fact that the user has repeatedly performed the input operation.

In addition, as described above, the information processing device 100 is configured in such a manner that in the above-described configuration, the operation determining unit 120 determines whether or not the function input operation performed by the user is a repetition of the predetermined operation pattern, by determining whether or not the operation obtaining unit 110 has repeatedly obtained a single type of predetermined function operation information within a predetermined period, on the basis of the plurality of pieces of function operation information obtained by the operation obtaining unit 110.

By this configuration, when the user has repeatedly performed an input operation for allowing a function of the device 1 to be performed, the information processing device 100 can notify the user of the fact that the user has repeatedly performed the input operation.

In addition, as described above, the information processing device 100 is configured in such a manner that in the above-described configuration, the operation determining unit 120 determines whether or not the function input operation performed by the user is a repetition of the predetermined operation pattern, by determining whether or not the operation obtaining unit 110 has repeatedly obtained, within a predetermined period, a set of pieces of function operation information including a plurality of different types of predetermined function operation information, on the basis of the plurality of pieces of function operation information obtained by the operation obtaining unit 110.

By this configuration, when the user has repeatedly performed an input operation for allowing a function of the device 1 to be performed, the information processing device 100 can notify the user of the fact that the user has repeatedly performed the input operation.

In addition, as described above, the information processing device 100 is configured in such a manner that in the above-described configuration, when the notification output unit 130 outputs the notification information, the notification output unit 130 outputs the notification information including confirmation information that confirms whether or not it is acceptable to perform the function corresponding to the function operation information obtained by the operation obtaining unit 110, and the operation obtaining unit 110 obtains operation information corresponding to an input operation from the user in response to the confirmation information included in the notification information.

By this configuration, when the user has repeatedly performed an input operation for allowing a function of the device 1 to be performed, the information processing device 100 can notify the user of the fact that the user has repeatedly performed the input operation, and when the input operation is an operation intended by the user, the information processing device 100 can allow the device 1 to perform a function corresponding to the input operation.

In addition, as described above, the information processing device 100 is configured in such a manner that in the above-described configuration, when the notification output unit 130 outputs the notification information, the notification output unit 130 outputs the notification information including, as operation history information, the plurality of pieces of function operation information obtained by the operation obtaining unit 110.

By this configuration, when the user has repeatedly performed an input operation for allowing a function of the device 1 to be performed, the information processing device 100 can provide the user with information indicating a history of input operations performed by the user, while notifying the user of the fact that the user has repeatedly performed the input operation.

In addition, as described above, the information processing device 100 is configured in such a manner that in the above-described configuration, when the function input operation performed by the user is a repetition of the predetermined operation pattern, the operation determining unit 120 counts the number of repetitions of the operation pattern, and when the notification output unit 130 outputs the notification information, the notification output unit 130 outputs the notification information in a mode corresponding to the number of repetitions counted by the operation determining unit 120.

By this configuration, when the number of times at which the user has repeatedly performed an input operation for allowing a function of the device 1 to be performed is large, the information processing device 100 can more surely make the user aware of the notification.

Note that in the present disclosure, modification to any component of the embodiment or omission of any component in the embodiment is possible within the scope of the present disclosure.

### INDUSTRIAL APPLICABILITY

An information processing device according to the present disclosure can be used in devices such as home appliances, portable terminals, or smart speakers.

### REFERENCE SIGNS LIST

1: device, 10: operating unit, 20: output unit, 30: function performing unit, 100: information processing device, 110: operation obtaining unit, 120: operation determining unit, 130: notification output unit, 140: operation information output unit, 201: processor, 202: memory, 203: processing circuit

1. An information processing device comprising:
operation obtaining circuitry to obtain operation information corresponding to an input operation performed by a user;
operation determining circuitry to determine whether or not a function input operation performed by the user is an operation intended by the user, by determining whether or not the function input operation performed by the user is a repetition of a predetermined operation pattern, on a basis of a plurality of pieces of function operation information corresponding to the function input operation among a plurality of pieces of operation information obtained by the operation obtaining circuitry, the function input operation being an input operation for allowing a function of a device to be performed; and
notification output circuitry to output, when the operation determining circuitry determines that the function input operation performed by the user is not an operation intended by the user, notification information indicating that the user has performed the function input operation by repeating the predetermined operation pattern.

2. The information processing device according to claim 1, wherein
the operation determining circuitry determines whether or not the function input operation performed by the user is a repetition of the predetermined operation pattern, by determining whether or not the operation obtaining circuitry has repeatedly obtained a single type of predetermined function operation information within a predetermined period, on a basis of the plurality of pieces of function operation information obtained by the operation obtaining circuitry.

3. The information processing device according to claim 1, wherein
the operation determining circuitry determines whether or not the function input operation performed by the user is a repetition of the predetermined operation pattern, by determining whether or not the operation obtaining circuitry has repeatedly obtained, within a predetermined period, a set of pieces of function operation information including a plurality of different types of predetermined function operation information, on a basis of the plurality of pieces of function operation information obtained by the operation obtaining circuitry.

4. The information processing device according to claim 1, wherein
when the notification output circuitry outputs the notification information, the notification output circuitry outputs the notification information including confirmation information that confirms whether or not it is acceptable to perform the function corresponding to the function operation information obtained by the operation obtaining circuitry, and
the operation obtaining circuitry obtains operation information corresponding to an input operation from the user in response to the confirmation information included in the notification information.

5. The information processing device according to claim 1, wherein
when the notification output circuitry outputs the notification information, the notification output circuitry outputs the notification information including, as operation history information, the plurality of pieces of function operation information obtained by the operation obtaining circuitry.

6. The information processing device according to claim 1, wherein
when the function input operation performed by the user is a repetition of the predetermined operation pattern, the operation determining circuitry counts a number of repetitions of the operation pattern, and
when the notification output circuitry outputs the notification information, the notification output circuitry outputs the notification information in a mode corresponding to the number of repetitions counted by the operation determining circuitry.

7. An information processing method comprising:
obtaining operation information corresponding to an input operation performed by a user;
determining whether or not a function input operation performed by the user is an operation intended by the user, by determining whether or not the function input operation performed by the user is a repetition of a predetermined operation pattern, on a basis of a plurality of pieces of function operation information corresponding to the function input operation among a plurality of pieces of operation information obtained, the function input operation being an input operation for allowing a function of a device to be performed; and
outputting notification information indicating that the user has performed the function input operation by repeating the predetermined operation pattern, when it is determined that the function input operation performed by the user is not an operation intended by the user.
